(19) United States
(12) Patent Application Publication
(10) Pub. No.: US 2016/0350214 A1
(43) Pub. Date: Dec. 1, 2016

(54) IDLE TIME SOFTWARE GARBAGE COLLECTION

(71) Applicant: Google Inc., Mountain View, CA (US)

(72) Inventors: Hannes PAYER, Munich (DE); Jochen Mathias EISINGER, Munich (DE); Manfred ERNST, Sunnyvale, CA (US); Ross Cameron MCILROY, Walton on Thames (GB)

(21) Appl. No.: 14/726,383

(22) Filed: May 29, 2015

(51) Int. Cl. G06F 12/02; G06F 17/30

(52) U.S. Cl. CPC G06F 12/0269; G06F 17/30607; G06F 2212/702

(57) ABSTRACT

A computing device schedules software garbage collection for software applications during processor idle periods. A future idle period of time during which a processor will be in an idle state during execution of one or more software applications is determined and an allocation of memory is measured for the future idle period of time. One of a plurality of predetermined software garbage collection events is based on the determined future idle period of time and the estimated allocation of memory, and scheduled to be performed during the future idle period of time. The selected software garbage collection event is then performed during the future idle period of time.

### BACKGROUND

Garbage collection is a form of automated memory management in which a runtime environment attempts to reclaim memory occupied by data objects that are no longer in use by software applications operating within the environment. One goal of software garbage collection may be to free up memory to provide a leaner operating environment, thereby enhancing operation efficiency. However, software garbage collection may occur at unpredictable points in time, and may have a negative impact on user experience. For example, software garbage collection may cause a pause in the rendering of a user interface or during a period of time in which the user is interacting with the user interface. Moreover, the amount of memory to be marked for garbage collection often varies and extended execution times may be required to free unused application memory.

### SUMMARY

The subject technology provides a system and computer-implemented method for scheduling software garbage collection during processor idle periods. In one or more implementations, the method comprises determining a future idle period of time during which one or more processors will be in an idle state during execution of one or more software applications, estimating, for the future idle period of time, an allocation of memory for the one or more software applications, selecting one of a plurality of predetermined software garbage collection events based on the determined future idle period of time and the estimated allocation of memory, scheduling the selected software garbage collection event to be performed during the future idle period of time, and performing the selected software garbage collection event during the future idle period of time. Other aspects include corresponding systems, apparatuses, and computer program products for implementation of the computer-implemented method.

In one or more implementations, a system comprises one or more processors and a memory including instructions. The instructions, when executed by the one or more processors, cause the one or more processors to facilitate the steps of determining a future idle period of time during which the one or more processors will be in an idle state during execution of one or more software applications, estimating, for the future idle period of time, an allocation of memory for the one or more software applications, selecting one of a plurality of predetermined software garbage collection events based on the determined future idle period of time and the estimated allocation of memory, scheduling the selected software garbage collection event to be performed during the future idle period of time, and performing the selected software garbage collection event during the future idle period of time. Other aspects include corresponding apparatuses, and computer program products for implementation of the foregoing system.

In one or more implementations, a computer-readable storage medium comprises instructions that, when executed, facilitate the steps of determining a future idle period of time during which one or more processors will be in an idle state during execution of one or more software applications, estimating, for the future idle period of time, an allocation of memory for the one or more software applications, selecting one of a plurality of predetermined software garbage collection tasks based on the determined future idle period of time and the estimated allocation of memory, scheduling the selected software garbage collection task to be performed during the future idle period of time, and performing the selected software garbage collection task during the future idle period of time. Other aspects include corresponding methods, apparatuses, and computer program products for implementation of the foregoing computer-readable storage medium.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

A detailed description will be made with reference to the accompanying drawings:

FIG. 1 depicts an example system, including example components for scheduling software garbage collection during processor idle periods.

FIG. 2 depicts a diagram of an example schedule of pending tasks, including idle tasks.

FIG. 3 depicts a flow diagram of a first example process for scheduling software garbage collection during processor idle periods.

FIG. 4 is a diagram illustrating an example electronic system for use in connection with scheduling software garbage collection during processor idle periods.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology includes a mechanism for scheduling software garbage collection during processor idle periods to reduce uneven performance in systems that use garbage collection to free up memory for software applications. A memory manager and a task scheduler (e.g., a back-end software component) perform several runtime estimations to determine whether and at what times memory used by running software applications should be garbage collected such as to reduce the negative impact of the garbage collection on the performance of the applications. In this regard, the memory manager and task scheduler determine future idle times of the processor, how much garbage collection may be required when those idle times arise, prioritize garbage collection events required to complete the estimated garbage collection, and schedule the prioritized garbage collection events during the determined idle times.

As an example, a scheduler schedules system and application tasks, organizes tasks by different task types (e.g., compositor tasks, generic tasks, etc.), and decides which type of task should be executed at a particular time. The task scheduler determines a future period of time in which a processor will be in an idle state. The scheduler also determines what tasks may be classified as idle tasks; e.g., tasks that are not required for current operation of the system or executing application. Garbage collection is an example task that may be classified as an idle task. The scheduler maintains a queue of pending idle tasks and may schedule these tasks during idle periods of task execution.

The memory manager estimates how much memory has been allocated, and estimates how much memory may be allocated at future idle times determined by the scheduler. Accordingly, garbage collection may be scheduled at appropriate idle times. For example, the memory manager may determine that x MB has been allocated and that a rate of allocation is y MB/ms. If the next idle time is in 3 ms then x+3y MB is estimated to be allocated by the next idle time. Based on this calculation, the memory manager may estimate how long it may take to garbage collect the memory, for example, based on past garbage collection events.

The memory manager may provide time estimations for multiple different garbage collection events, including garbage collection marking for newly allocated objects, garbage collection marking for old objects, garbage collection finalization, and memory sweeping. Each time estimation may be made based on a respective event and an estimated memory allocation corresponding to an upcoming idle time. Since upcoming idle times may not be long enough to complete an entire event, the memory manager may break up events into smaller chunks of operations. For example, the marking of old objects for garbage collection may be separated into incremental marking steps. The memory manager may calculate a time estimation for each step, taking into consideration estimated memory allocation over several pending idle times.

The memory manager may only attempt to schedule garbage collection events when the memory allocation has reached, or is estimated to reach, a threshold allocation. The threshold allocation may be, for example, a predetermined amount of memory required to be allocated by a predetermined time (e.g., at the next idle time), or a predetermined threshold allocation rate. The memory manager may add garbage collection events and their estimated completion times to the task scheduler as idle events, and the scheduler may select the events based on event size and scheduled idle times. Garbage collection events may be grouped in FIFO order. For example, multiple events may be required to incrementally mark objects, and each event may be scheduled as a time-portioned chunk (e.g., 10 ms, 20 ms, 50 ms, etc.). The garbage collection events may be scheduled to be performed at future idle periods of time in their scheduled order.

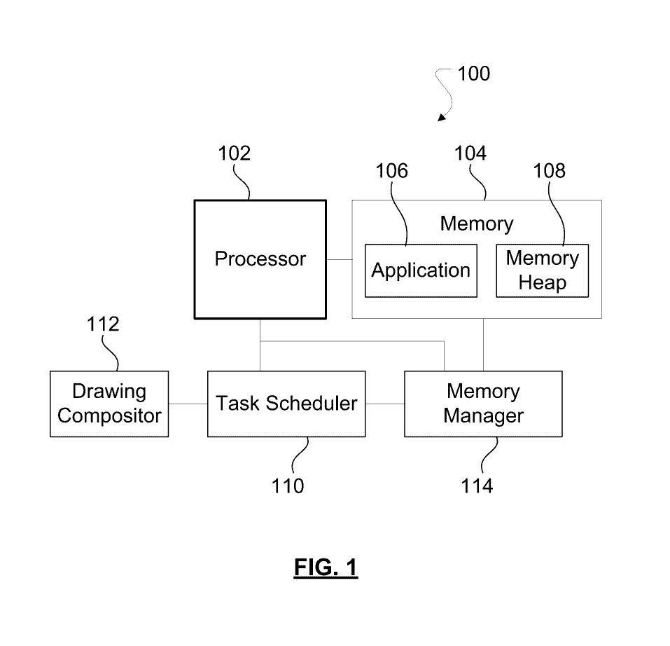

FIG. 1 depicts an example system 100, including example components for scheduling software garbage collection during processor idle periods, according to one or more aspects of the subject technology. System 100 includes a processor 102 and a memory 104. When an application process 106 begins, the executable file corresponding to the process is mapped into a virtual address space in memory 104 that is allocated for the process 106. The virtual address space may also include an object heap 108. Object heap 108 may be made available to additional libraries mapped into the address space. Object heap 108 may be managed by the application or the runtime environment (including, e.g., an operating system or virtual machine) in which the application operates. This management may include garbage collection to free up memory space during execution of process 106. Application process 106 may be a web application, an executing processes derived from a scripting or compiled dynamic programming language within the web application or other application capable of executing within a runtime environment.

System 100 further includes a task scheduler 110 that decides which tasks get to execute on the main thread at any given time. Accordingly, task scheduler 110 enables prioritization of latency sensitive tasks (e.g., input events or compositor updates). In one or more implementations, task scheduler 110 includes multiple software components, with one or more components being part of or embedded within a software garbage collector adapted according to the subject technology. Additionally or in the alternative, task scheduler 110 may include one or more components in communication with the software garbage collector (e.g., via an API (application programming interface)). In this regard, one or more components of task scheduler 110 may inform task scheduling-related components within the garbage collector of processor idle times. Accordingly, the components of task scheduler 110 enable tasks to be posted to different task types (e.g., compositor tasks, garbage collection tasks, generic tasks, etc.), which enables the components of the task scheduler (e.g., within the garbage collector) to decide which type of task should be executed at a particular time. Task scheduler 110 may categorize a task as an idle task.

Task scheduler 110 maintains the queue of pending idle tasks, and will schedule these tasks during idle periods of execution. The task scheduler 110 may use notifications from a drawing compositor 112 about frame begin and commit events, as well status of other tasks currently pending (e.g., higher priority tasks), to schedule idle events at times when they will not cause an increase in frame latency. Idle tasks may also be performed, for example, during longer idle periods when no frames are being committed by drawing compositor 112. Task scheduler 110 may re-order tasks with respect to other tasks. Each task may be associated with a task deadline, provided by task scheduler 110. If a task cannot be completed before the deadline expires, the task may be rescheduled to perform during the next idle period.

During an idle period, the scheduler may take the oldest task from the pending queue, and schedule its execution with a deadline which is less than or equal to the remaining idle period time. If the task completes before this deadline then the scheduler may continue execution of idle tasks in FIFO (first in first out) order until the deadline. An idle task may only be executed once, and when executed task scheduler 110 may determine whether the task can do any useful work in the time allowed before the deadline expires. If no useful work can be done, the task may not be executed but instead reposted to the idle queue. The majority of idle tasks may, for example, be executed between frames. In this regard, the deadline may be a time period of x duration, for example, less than or equal to 10 ms, 25 ms, 50 ms, etc.

In some implementations, idle tasks posted to task scheduler 110 may be appended to an incoming idle task queue. At the beginning of a new idle period, incoming tasks may be flushed to a pending idle task queue, where task scheduler 110 may execute them in a FIFO manner. In this example, idle tasks may re-post themselves during their own execution, even if they could do no real work before the deadline expired. In one or more implementations, task scheduler 110 may schedule higher priority tasks (e.g., compositor or input tasks) during idle times in preference to idle tasks.

Task scheduler 110 may use various signals to decide when idle periods should begin and end. For example, task scheduler 110 may use an input from a software drawing compositor 112 (e.g., part of a software runtime environment or application process responsible for drawing the user interface or a portion thereof) to ensure that idle tasks are only scheduled between the time when a frame has been committed, and the time when the next frame is expected to begin. Accordingly, idle periods to inter-frame times are limited, and no idle periods may occur when the compositor is not active (due to frames not being drawn). One example may include posting a delayed task which will trigger an idle period if no frames have been drawn for a period of time.

As depicted in FIG. 1, system 100 may further include a memory manager 114. Memory manager 114 manages memory for the software runtime environment and is configured to monitor memory allocation and post garbage collection events (as tasks) to task scheduler 110 based on a determined memory allocation. As described previously, memory manager 114 may estimate how much memory has been allocated, and how much memory may be allocated at future idle times determined by task scheduler 110.

Memory manager 114 may, for example, poll task scheduler 110 to determine the next idle time(s) and determine based on a rate of allocation how much memory will be allocated by the next idle time(s). Memory manager 114 may then estimate how long it may take to garbage collect the memory, for example, based on the estimated memory allocation and past garbage collection events. For example, memory manager 114 may estimate the duration of garbage collection based on average memory allocation rate of the application, average garbage collection time for young and/or old objects (e.g., per MB), and the average marking speed (e.g., per MB). Other example factors for estimating the duration of a garbage collection event may include heap state (e.g., percentage fragmented, consistent, corrupted), percentage of heap committed, free, reserved, allocation load, and marking speed (e.g., based on past speeds).

Memory manager 114 may trigger incremental garbage collection (e.g., linearly configured from 0 ms-XXms), scavenges (e.g., about 5-10 ms) and long full garbage collections (e.g., 30-XXXms). Memory manager 114 may post each garbage collection event to task scheduler 110, including an estimated time for the task to be completed. In some implementations, memory manager 114 may break up larger events or tasks into smaller chunks if they are more than a predetermined length, or organize garbage collection events into tasks of a predetermined duration (e.g., 10 ms or 50 ms).

In one or more implementations, task scheduler 110 maintains a global list of pending tasks (including garbage collection tasks) and prioritizes them. In one example, memory manager 114 may post a garbage collection event or portion of the event as an idle task to the main thread, including a priority for the task and the type of event (e.g., marking, finalization, sweeping, compaction), and an estimated execution time for the task. In this manner, memory manager 114 may post garbage collection tasks to task scheduler 110, and drawing compositor 112 may notify task schedule 110 about good opportunities to run pending idle tasks, and task scheduler 110 may then determine which task to run and at what time.

Task manager 110 and memory manager 114 may be implemented outside of a runtime environment (e.g., a virtual machine) to manage task organization and priority, as well as garbage collection of objects created within the runtime environment (e.g., through one or more APIs). Additionally or in the alternative, components of task manager 110 and memory manager 114 may be a part of or embedded within the runtime environment. The runtime environment may be part of or embedded within a web browser application and/or responsible for web applications (e.g., JAVASCRIPT, JAVA applets) and other dynamic programming languages running within the runtime environment. In one or more implementations, drawing compositor 112 may be a display rendering component of the runtime environment responsible for redrawing frames within the display (e.g., of a window) for an application process 106.

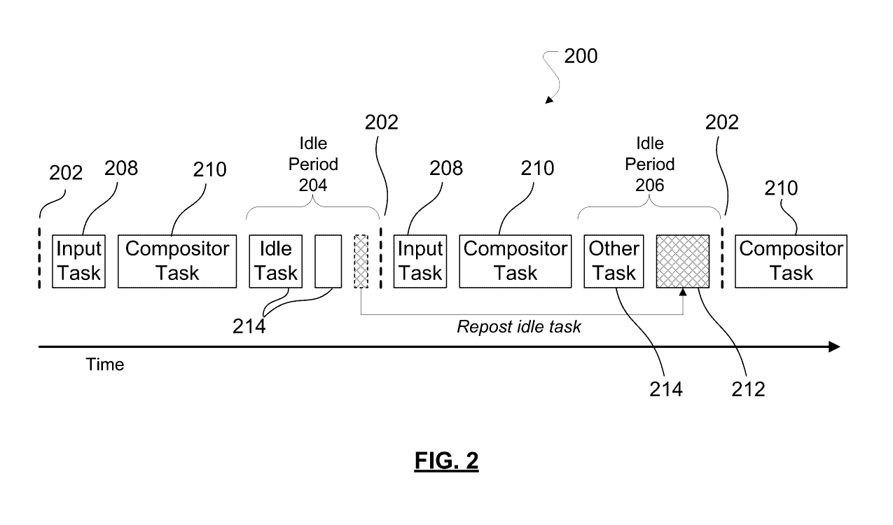

FIG. 2 depicts a diagram of an example schedule 200 of pending tasks, including idle tasks, according to aspects of the subject technology. Task scheduler 110 receives notifications from drawing compositor 112 of frame start times 202 (e.g., based on a predetermined frame rate), and sets up a schedule of tasks based on frame start times 202. The depicted example includes three frame start times 202 defining two consecutive task periods. Task scheduler 110 receives application tasks from application 106 and/or the runtime environment and organizes them such that drawing latency is reduced or eliminated based on the frame rate. For example, task scheduler 110 may monitor a command queue for the runtime environment for messages (e.g., from compositor 112) regarding frame start and determine idle periods 204, 206 between consecutive start times 202.

As depicted, task scheduler 110 may schedule essential tasks such as input tasks 208 (e.g., defining a user inputted key or command) and compositor tasks 210 (e.g., to draw the frame) first, with a remaining time until the next frame start defining an idle period 204, 206. In one or more implementations, idle periods 204, 206 may be determined, for example, from a frame end (e.g., frame commit) time to the next frame start time 202. Idle periods 204, 206 may be used by task scheduler 110 to post tasks in a task queue, including garbage collection tasks.

In some aspects, an idle task (e.g., a garbage collection task) may not be able to be completed within an idle period. For example, task scheduler 110 may attempt to post idle task 212, a 50 ms task, to idle period 204. However, task manager 110 has already scheduled one or more high priority tasks 214 during the idle period 204, leaving less than 50 ms available for idle task 212 to be completed. In this situation example idle task 212 returns immediately and is reposted to a subsequent idle period having a long-enough duration to complete the reposted task, for example, idle period 206 in FIG. 2.

In some implementations, task scheduler 110 may limit idle task execution to one intra-frame period, and prevent tasks that cannot be completed within a current deadline from reposting themselves during the remainder of the same idle period. This may prevent a task from reposting itself repeatedly for the remainder of the idle period and burning CPU power unnecessarily.

In one or more implementations, task scheduler 110 may determine, based on input from drawing compositor 112, a longer idle periods wherein no frames have been committed by drawing compositor 112. In this instance, idle tasks may not be limited to a predetermined chunk duration (e.g., 50 ms idle task) during a single idle period 204, 206. Task scheduler 110 may be configured to schedule the whole of the idle period to do any necessary background work; as long as the tasks scheduled therein yield back scheduling control to the scheduler at the end of each predetermined chunk duration (e.g., each 50 ms) to prevent blocking of input events, and thus noticeable latency to the input events. During long idle periods 204, 206 (e.g., over a predetermined duration), tasks may be allowed to repost to the same idle period. As long as the remainder of the idle period is long enough to complete the idle task duration, the idle task should not be rejected; thus, preventing the ability for the task to attempt to repeatedly repost itself.

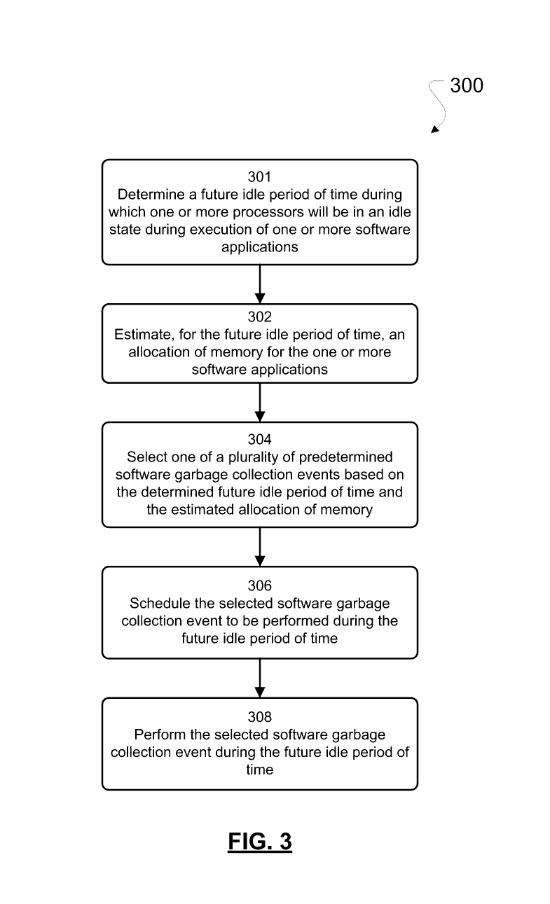

FIG. 3 depicts a flow diagram of a first example process 300 for scheduling software garbage collection during processor idle periods, according to aspects of the subject technology. For explanatory purposes, example process 300 is described herein with reference to the components of FIG. 1 and FIG. 2. Further for explanatory purposes, the blocks of example process 300 are described herein as occurring in serial, or linearly. However, multiple blocks of example process 300 may occur in parallel. In addition, the blocks of example process 300 need not be performed in the order shown and/or one or more of the blocks of example process 300 need not be performed.

In the depicted example flow diagram, system 100 (e.g., task scheduler 110) determines a future idle period of time (e.g., idle period 204) during which processor 102 will be in an idle state during execution of one or more software applications (302). As described above, the future idle period of time may be determined by a first frame rendering start time and a second frame rendering time. Frame start times may be determined from drawing compositor 112. Drawing compositor 112, for example, may schedule frames with task scheduler 110 according to a predetermined frame rate. For example, 60 fps (frames per second) drawing compositor may post frame start times to begin each 16.6 ms. The determined future idle period may be a period of time between the first frame rendering start time and the second frame rendering start time that does not include application tasks (e.g., input tasks, compositor tasks) that are required by the application or runtime environment.

In user-interactive applications (e.g., JavaScript applications that implement layout and rasterization), a frame computation time of greater than 16.6 ms may be considered to have an undesirably high latency. However, the same applications may include garbage collection processes that, when performed, are longer than the frame duration and thereby cause undesirable, user-perceivable pauses in frame drawing. For example, garbage collection may include multiple different events including, for example, scavenging, marking, and compaction of the marked objects that, when committed, require a substantial amount of time to be performed collectively. Turning off garbage collection may cause out-of-memory errors, and calling garbage collection programmatically may negatively impact garbage collection heuristics. In many instances, applications should not interact with the garbage collector. Accordingly, the subject technology automatically separates the various garbage collection events into smaller, more manageable chunks that can be posted to task scheduler 110 as idle tasks, and performed while the system is in an idle state. Accordingly, garbage collection remains hidden from the application but reduces the possibility of frame delay.

Accordingly, to break up garbage collection events, system 100 first determines how much garbage collection is required. In this regard, system 100 (e.g., memory manager 114) estimates, for the future idle period of time, an allocation of memory for the one or more software applications (304). Memory manager 114 may estimate how long it may take to garbage collect the memory for each different type of available garbage collection events. For example, memory manager 114 may estimate the duration of garbage collection for young and/or old objects (e.g., per MB), marking the young and/or old objects (e.g., per MB), and compaction. Memory manager 114 may provide estimates for each event based on various factors, including heap state (e.g., percentage fragmented, consistent, corrupted), percentage of heap committed, free, reserved, rate of allocation, allocation load, and garbage collection marking speed (e.g., based on past speeds).

Memory manager 114 may, for example, poll task scheduler 110 to determine the next idle time(s), and determine based on a rate of allocation (past or current) how much memory will be allocated by the next idle time(s) based on the foregoing factors. For example, memory manager 114 may determine that x MB has been allocated and that a current rate of allocation is y MB/ms. If the next idle time is in 3 ms then x+3y MB is estimated to be allocated by the next idle time. Once the allocation is determined, memory manager 114 may determine how much time each type of event may take.

Garbage collection events may be broken up into predetermined event tasks, each event task is a chunk of the event that includes a series of subtasks or commands. Each task is generated so that it may be executed in a predetermined duration. For example, if a garbage collection event such as marking old object is estimated to take 400 ms then the event may be divided into eight 50 ms tasks (or some other predetermined duration). System 100 may generate tasks for an event based on any predetermined amount of time. For example, each task may be 10 ms, 25 ms, 50 ms, etc.

In some aspects, the estimated allocation of memory may be based on an allocation of memory over multiple future scheduled idle times. For example, memory manager 114 may determine that a previously generated garbage collection task 212 was returned after being posted to task scheduler 110 for an idle period 204. Memory manager 114 may then recalculate the memory allocation for a subsequent idle period 206. Additionally or in the alternative, memory manager 114 may determine that a garbage collection event cannot be completed in a single idle period. Accordingly, memory manager 114 may determine an estimated number of idle periods to complete the event and determine the memory allocation for the number of idle periods.

With further reference to FIG. 3, system 100 (e.g., task scheduler 110) selects one of a plurality of predetermined software garbage collection events based on the determined future idle period of time and the estimated allocation of memory (306). In one or more implementations, a garbage collection event will only be selected if it is first determined that the estimated allocation of memory satisfies a threshold allocation of memory, for example, at the determined future idle period of time. The threshold may be based on total allocation, rate of allocation, allocation of young or old objects, etc. In one or more implementations, task scheduler 110 may analyze the types of garbage collection events in an event queue and schedule the events (or tasks for the events) to maximize performance of the system. Task scheduler 110 (or, e.g., a system garbage collector adapted with components of task scheduler 110) may select an event that may be completed in a single idle period or over a minimum number of idle periods for the events in the queue (e.g., as a series of tasks). Task scheduler 110 may schedule tasks for an event that provides the most memory optimization (e.g., via garbage collection) in the smallest duration of time or smallest number of task chunks.

In one or more implementations, task scheduler 110 may select a garbage collection event to be scheduled based on one or more predetermined rules. For example, a young generation garbage collection may be selected when the young generation is almost full (e.g., greater than 90 percent full). Incremental marking of objects (e.g., a number of objects being marked in chunked tasks of a predetermined time duration) may be initiated when an old generation of objects is almost full (e.g., objects created more than a predetermined time before a current time greater than 90 percent full). Subsequent marking steps may be selected when marking was started in an earlier idle period. A full garbage collection may be initiated and scheduled when task scheduler 110 determines enough idle time is available for the garbage collection to be completed without inducing latency.

In some aspects, when the selected garbage collection event is an object marking event, the event may be fragmented into a plurality of incremental object marking tasks, a first of the incremental object marking tasks being scheduled to be performed first during the previously described future idle period of time. As described previously, the plurality of incremental object marking tasks may be scheduled to be split between two or more different idle periods of time

Accordingly, a time estimation for completing each of the plurality of predetermined software garbage collection events may be determined based on the estimated allocation of memory, and a garbage collection event selected based on a respective time estimation corresponding to the selected software garbage collection event and a duration of the future idle period of time.

With further reference to FIG. 3, system 100 (e.g., task scheduler 110) schedules the selected software garbage collection event to be performed during the future idle period of time (308). Additionally or in the alternative, a group of tasks may be scheduled during an idle period of time. For example, task scheduler 110 may determine that the future idle period of time corresponds to a pause in rendering frames for the one or more software applications (e.g., a long idle time). Accordingly, task scheduler 110 may schedule a group of the software garbage collection tasks to be performed during the future idle period of time, the group comprising at least a portion of the selected software garbage collection event. In this example, a time duration of the group is greater than a duration of a single respective frame (e.g., greater than 16.6 ms).

System 100 then performs the selected software garbage collection event during the future idle period of time (310). As described previously, the event may be performed as a series of tasks (e.g., each of a predetermined duration). In some instances, the event may only be one task, or a few tasks, that may be performed in the same idle period. However, the future idle period of time may be continuous or may span several frames (e.g., between system tasks and the end of each frame).

Many of the above-described example processes 200, 300 and 400, and related features and applications, may be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

The term “software” is meant to include, where appropriate, firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

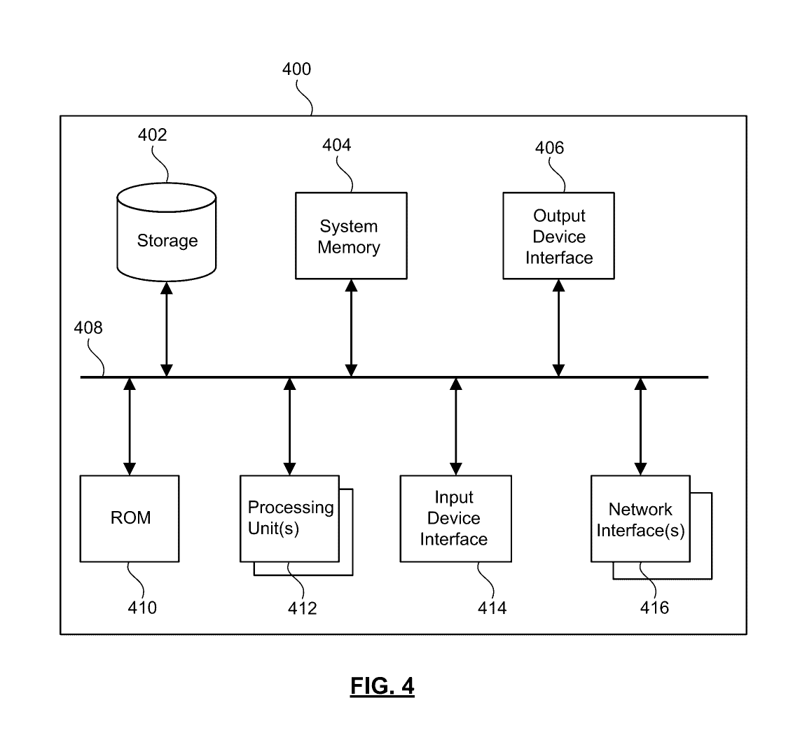

FIG. 4 is a diagram illustrating an example electronic system 400 for use in connection with scheduling software garbage collection during processor idle periods, according to one or more aspects of the subject technology. Electronic system 400 may be a computing device for execution of software associated with the operation of computing device 100, or one or more portions or steps of process 300, or components and processes provided by FIGS. 1-3. In various implementations, electronic system 400 may be representative of system 100. In this regard, electronic system 400 or system 100 may be a personal computer or a mobile device such as a tablet computer, laptop, smartphone, PDA, or other touch screen or television with one or more processors embedded therein or coupled thereto, or any other sort of computer-related electronic device having wireless connectivity.

Electronic system 400 may include various types of computer readable media and interfaces for various other types of computer readable media. In the depicted example, electronic system 400 includes a bus 408, processing unit(s) 412, a system memory 404, a read-only memory (ROM) 410, a permanent storage device 402, an input device interface 414, an output device interface 406, and one or more network interfaces 416. In some implementations, electronic system 400 may include or be integrated with other computing devices or circuitry for operation of the various components and processes previously described.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through network interfaces 416. Network interfaces 416 may include, for example, a wireless access point (e.g., Bluetooth or WiFi) or radio circuitry for connecting to a wireless access point. Network interfaces 416 may also include hardware (e.g., Ethernet hardware) for connecting the computer to a part of a network of computers such as a local area network (“LAN”), a wide area network (“WAN”), wireless LAN, or an Intranet, or a network of networks, such as the Internet. Any or all components of electronic system 400 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The term website, as used herein, may include any aspect of a website, including one or more web pages, one or more servers used to host or store web related content, and the like. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A computer-implemented method, comprising:
determining a future idle period of time during which one or more processors will be in an idle state during execution of one or more software applications;
estimating, for the future idle period of time, an allocation of memory for the one or more software applications;
selecting one of a plurality of predetermined software garbage collection events based on the determined future idle period of time and the estimated allocation of memory;
scheduling the selected software garbage collection event to be performed during the future idle period of time; and
performing the selected software garbage collection event during the future idle period of time.

2. The computer-implemented method of claim 1, wherein the selecting comprises
determining a time estimation for completing each of the plurality of predetermined software garbage collection events based on the estimated allocation of memory; and
selecting the selected software garbage collection event based on a respective time estimation corresponding to the selected software garbage collection event and a duration of the future idle period of time.

3. The computer-implemented method of claim 1, further comprising:
determining a first frame rendering start time and a second frame rendering time based on a frame rate and one or more software application tasks,
wherein the future idle period of time is between the first frame rendering start time and the second frame rendering start time.

4. The computer-implemented method of claim 1, wherein the selected garbage collection event comprises a group of garbage collection tasks, the method further comprising:
determining that the future idle period of time corresponds to a pause in rendering frames for the one or more software applications; and
scheduling the group of the software garbage collection tasks to be performed during the future idle period of time, a time duration of the group being greater than a duration of a respective frame.

5. The computer-implemented method of claim 1, further comprising:
determining that the estimated allocation of memory will satisfy a threshold allocation of memory at the future idle period of time.

6. The computer-implemented method of claim 5,
wherein estimating the allocation of memory comprises determining a current rate of memory allocation, and
wherein determining that the estimated allocation of memory will satisfy a threshold allocation of memory is based on the current rate of memory allocation.

7. The computer-implemented method of claim 1, wherein the estimated allocation of memory is based on an allocation of memory over multiple future scheduled idle times.

8. The computer-implemented method of claim 1, wherein the plurality of predetermined software garbage collection events comprise object marking, finalization, and memory sweeping.

9. The computer-implemented method of claim 8, wherein the selected garbage collection event is an object marking event, the method further comprising:
fragmenting the object marking event into a plurality of incremental object marking tasks, a first of the incremental object marking tasks being scheduled to be performed first during the future idle period of time.

10. The computer-implemented method of claim 9, wherein the plurality of incremental object marking tasks are scheduled to be split between two or more different idle periods of time.

11. A system, comprising:
one or more processors; and
a memory including instructions that, when executed by the one or more processors, cause the one or more processors to facilitate the steps of:
determining a future idle period of time during which the one or more processors will be in an idle state during execution of one or more software applications;
estimating, for the future idle period of time, an allocation of memory for the one or more software applications;
selecting one of a plurality of predetermined software garbage collection events based on the determined future idle period of time and the estimated allocation of memory;
scheduling the selected software garbage collection event to be performed during the future idle period of time; and
performing the selected software garbage collection event during the future idle period of time.

12. The system of claim 11, wherein the instructions, when executed, further cause the one or more processors to facilitate the steps of:
determining a time estimation for completing each of the plurality of predetermined software garbage collection events based on the estimated allocation of memory; and
selecting the selected software garbage collection event based on a respective time estimation corresponding to the selected software garbage collection event and a duration of the future idle period of time.

13. The system of claim 11, wherein the instructions, when executed, further cause the one or more processors to facilitate the steps of:
determining a first frame rendering start time and a second frame rendering time based on a frame rate and one or more software application tasks,
wherein the future idle period of time is between the first frame rendering start time and the second frame rendering start time.

14. The system of claim 11, wherein the selected garbage collection event comprises a group of garbage collection tasks, and wherein the instructions, when executed, further cause the one or more processors to facilitate the steps of:
determining that the future idle period of time corresponds to a pause in rendering frames for the one or more software applications; and
scheduling the group of the software garbage collection tasks to be performed during the future idle period of time, a time duration of the group being greater than a duration of a respective frame.

15. The system of claim 11, wherein the instructions, when executed, further cause the one or more processors to facilitate the steps of:
determining that the estimated allocation of memory will satisfy a threshold allocation of memory at the future idle period of time,
wherein estimating the allocation of memory comprises determining a current rate of memory allocation, and
wherein determining that the estimated allocation of memory will satisfy a threshold allocation of memory is based on the current rate of memory allocation.

16. The system of claim 11, wherein the estimated allocation of memory is based on an allocation of memory over multiple future scheduled idle times.

17. The system of claim 11, wherein the plurality of predetermined software garbage collection events comprise object marking, finalization, and memory sweeping.

18. The system of claim 17, wherein the selected garbage collection event is an object marking event, and wherein the instructions, when executed, further cause the one or more processors to facilitate the steps of:
fragmenting the object marking event into a plurality of incremental object marking tasks, a first of the incremental object marking tasks being scheduled to be performed first during the future idle period of time.

19. The system of claim 18, wherein the plurality of incremental object marking tasks are scheduled to be split between two or more different idle periods of time.

20. A non-transitory computer-readable storage medium comprising instructions that, when executed, facilitate the steps of:
determining a future idle period of time during which one or more processors will be in an idle state during execution of one or more software applications;
estimating, for the future idle period of time, an allocation of memory for the one or more software applications;
selecting one of a plurality of predetermined software garbage collection tasks based on the determined future idle period of time and the estimated allocation of memory;
scheduling the selected software garbage collection task to be performed during the future idle period of time; and
performing the selected software garbage collection task during the future idle period of time.
